(19) United States
(12) Patent Application Publication
(10) Pub. No.: US 2011/0068953 A1
(43) Pub. Date: Mar. 24, 2011

(54) Vehicle Park Assist System and Method for Parking a Vehicle Using Such System

(76) Inventors: Salvador Toledo, Ypsilanti, MI (US); Dirk Gunia, Pulheim (DE); Janet Meise, Köln (DE); Steve M. Sundherg, Canton, MI (US)

(21) Appl. No.: 12/566,028

(22) Filed: Sep. 24, 2009

(51) Int. Cl. B60Q 1/48

(52) U.S. Cl. 340/932.2

(57) ABSTRACT

A park assist system for parking a vehicle in a target parking space includes a first sensing system which determines whether there is a sufficient slot length in a target parking space in which to park the vehicle. A second sensing system determines whether an obstacle is located in a predetermined clearance zone on a side of the vehicle opposite the target parking space. A decision regarding whether to recommend parking the vehicle in the target parking space sensed by the first sensing system is dependent upon a determination that the clearance zone is free of obstacles.

### BACKGROUND

This invention relates in general to vehicle park assist systems and in particular to an improved park assist system and method for parking of such a vehicle.

Vehicle park assist systems are used to identify a feasible parking space, e.g., usually a parallel space, a rear perpendicular space, or a garage parking space, and then take over the steering of the vehicle to maneuver the vehicle into the identified space hands free. During operation, the driver still shifts the transmission and operates the gas and brake pedals. Thus, while the steering is done automatically, the driver is still responsible for safe parking of the vehicle.

One known vehicle park assist system is disclosed in U.S. Pat. No. 6,948,729 to Zalila el al. In U.S. Pat. No. 6,948,729, sensors 36 sense front obstacles 4, back obstacles 16 and an edge 5 of the possible parking space 2. Sensed data is processed and an output is provided which assists the driver in parking the vehicle.

### SUMMARY

The present application describes various embodiments of a park assist system. One embodiment of the park assist system for parking a vehicle in a target parking space includes a first sensing system which determines whether there is a sufficient slot length in a target parking space in which to park the vehicle. A second sensing system determines whether an obstacle is located in a predetermined clearance zone on a side of the vehicle opposite the target parking space. A decision regarding whether to recommend parking the vehicle in the target parking space sensed by the first sensing system is dependent upon a determination that the clearance zone is free of obstacles.

According to another embodiment, a method for parking a vehicle in a target parking space includes a vehicle having a sensing system and a park assist system operatively connected thereto. Neighboring objects are scanned using a first sensor to determine if a target parking space is available for parking the vehicle. The neighboring objects include at least one object either in front of or behind the target parking space, and the first sensor provides an input signal to the park assist system. Neighboring objects on the side of the vehicle opposite the target parking space are scanned using a second sensor to determine if a clearance zone on the side of the vehicle opposite the target parking space is free of obstacles, and the second sensor provides an input signal to the park assist system. The park assist system is used to determine whether there is a sufficient slot length in which to park the vehicle and to determine whether there is sufficient clearance to an identified obstacle on the side of the vehicle opposite the target parking space. The vehicle is then parked in the target parking space using the park assist system if there is sufficient slot length in which to park the vehicle and sufficient clearance to an identified obstacle on the side of the vehicle opposite the target parking space.

According to yet another embodiment, a method for parking a vehicle in a target parking space includes a vehicle having a sensing system and a park assist system operatively connected thereto. A target parallel parking space is identified. Neighboring objects on the side of the vehicle opposite the target parking space are scanned using an ultrasonic sensor to determine if a clearance zone on the side of the vehicle opposite the target parking space is free of obstacles. The ultrasonic sensor provides an input signal to the park assist system. The park assist system is used to determine whether there is sufficient clearance to an identified obstacle on the side of the vehicle opposite the target parallel parking space. The vehicle is then parked in the target parking space using the park assist system if there is sufficient slot length in which to park the vehicle and sufficient clearance to an identified obstacle on the side of the vehicle opposite the target parking space.

Other advantages of the park assist system will become apparent to those skilled in the art from the following detailed description, when read in light of the accompanying drawings.

### BRIEF DESCRIPTION OF THE DRAWINGS

FIG. 1 is a schematic diagram of a first embodiment of a path to a target parking space and a clearance zone using a park assist system according to the present invention.

FIG. 1A is a schematic diagram of a portion of the park assist system illustrated in FIG. 1, showing the associated vehicle used therewith.

FIG. 2 is a flow chart of an embodiment of a method for parking a vehicle using the park assist system of the present invention.

### DETAILED DESCRIPTION

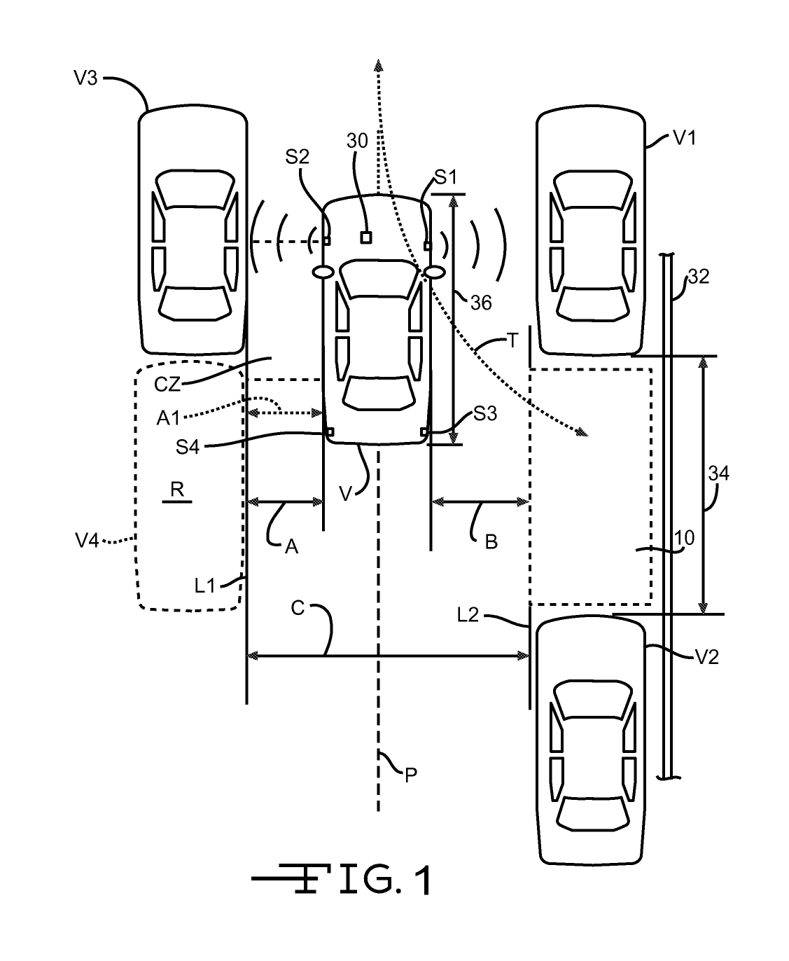

Referring now to FIG. 1, there is illustrated a schematic diagram of a first embodiment of a path P for parking of a vehicle V to a target parking space or space 10 between two parked vehicles V1 and V2, using a park assist system, which will be described in detail below, according to the present invention. In the illustrated embodiment, the vehicle V, schematically shown in FIG. 1A, includes at least the following components or systems: a brake pedal 12, a gas pedal 14, a braking system 16, a steering system 18, a driveline system 20, wheels 22, an electric power assisted steering (EPAS) system 24 which is part of the steering system 18, a sensing system 26, a powertrain system 28, and a park assist system 30. Alternatively, an electro-hydraulic power assisted steering system may be used in lieu of EPAS. The park assist system 30 is also shown schematically in FIG. 1. However, it must be understood that the vehicle V to be parked may include any other suitable components or systems and that only those components or systems which are necessary for describing and explaining the function and operation of the present invention are illustrated herein.

In the illustrated embodiment, the sensing system 26 is operatively connected to the park assist system 30 to provide input signal(s) thereto and preferably includes ultrasonic sensors, GPS and/or odometric sensors, and an absolute steering wheel angle sensor. Alternatively, the park assist system 30 may include a relative steering wheel angle sensor in lieu of an absolute steering wheel angle sensor, and radar, lidar, lasers, or thermal sensors may be used in lieu of the ultrasonic sensors. The ultrasonic sensors may be located on a side(s) of a front and/or rear bumpers of the vehicle V. In the illustrated embodiment of FIG. 1, ultrasonic sensors, indicated generally at S1 and S2 are illustrated schematically. The sensor S1 is shown as being located on a front passenger or right side bumper of the vehicle V. The sensor S2 is shown as being located on a front driver or left side bumper of the vehicle V.

Alternatively, the number and or the location of the ultrasonic sensors may be other than illustrated if so desired. For example, one or more ultrasonic sensors may be located on one or both of the rear bumpers of the vehicle (as shown as S3 and S4 in FIG. 1), or in any suitable combinations of or desired locations thereof on the vehicle V. The sensor or sensors S1 and/or S3 mounted on the passenger side of the vehicle V define a first sensing system. Similarly, the sensor or sensors S2 and/or S4 mounted on the driver side of the vehicle V define a second sensing system.

In the illustrated embodiment, the odometric sensors may be located on one or more of the wheels 22 of the vehicle V and/or in the driveline system 20 of the vehicle. The steering wheel angle sensor is located on the steering system 18 of the vehicle and preferably is located on a steering wheel of the steering system 18. Alternatively, the construction and/or the components of the sensing system 26 of the vehicle V may be other than illustrated and described if so desired.

In the illustrated embodiment, the vehicle V is parked into the target parking space 10 using the park assist system 30 of the present invention. To accomplish this, at least one of the ultrasonic sensors S1, S3 is used in conjunction with the odometric sensors and the steering wheel angle sensor to scan neighboring objects and their location relative to the position of the vehicle V as a driver of the vehicle drives by the objects. In the illustrated embodiment of FIG. 1, the neighboring objects are illustrated as being the two parked vehicles V1 and V2 and an object 32, such as for example, a curb or a wall. However, one or more of the neighboring objects may be other kinds or types than that which are illustrated and described. It will be understood that the park assist system 30 of the present invention may successfully identify a target parking space 10 relative to only one object or vehicle, such as either the vehicle V1 or the vehicle V2, is present and sensed.

The information from the sensors is processed by a computer of the park assist system 30 to determine if a valid path trajectory T can be performed to park the vehicle V into the target parking space 10. The calculation by the computer of the park assist system 30 includes a determination of a slot length 34 depending upon a length 36 of the vehicle V.

Additionally, the calculation by the computer of the park assist system 30 includes a determination of whether there is sufficient space to maneuver the vehicle V into the target parking space 10 by determining whether a neighboring object or potential obstacle is present on the side of the vehicle opposite the target parking space 10. To accomplish this, at least one of the ultrasonic sensors S2, S4 is used in conjunction with the odometric sensors and the steering wheel angle sensor to scan neighboring objects or potential obstacle(s) on the side of the vehicle V opposite the target parking space 10, and their position(s) relative to the vehicle V as a driver of the vehicle drives by the potential obstacle(s).

In the illustrated embodiment, the potential obstacle is illustrated as a vehicle V3 in the roadway R. In order for the vehicle V to successfully maneuver into the target parking space 10, a clearance zone CZ must be free of obstacles. A line L1 is parallel to the path P and runs through the closest point that the vehicle V3 may be to the vehicle V without encroaching into the path the vehicle V must travel to successfully maneuver into the target parking space 10. The clearance zone CZ is therefore defined as the space between the driver side of the vehicle V and the line L1. It will be understood that the potential obstacle may be more than one object, such as the vehicle V3 and another vehicle V4 in the roadway R in front of and/or behind the vehicle V.

As shown in FIG. 1, a predetermined lateral distance A is defined as the minimum lateral distance between the left or driver side of the vehicle V and the line L1, and defines a width of the clearance zone CZ.

A lateral distance B is the measured lateral distance between the right or passenger side of the vehicle V and a left-most edge, illustrated by the line L2, of the target parking space 10. A predetermined lateral distance C represents the minimum total lateral distance between the left-most edge L2 of the target parking space 10 and the left-most edge L1 of the clearance zone CZ required to successfully maneuver the vehicle V into the target parking space 10.

If the computer of the park assist system 30 determines that a measured lateral distance A1 to a potential obstacle, such as the vehicle V3, as measured by the sensor S2 and/or S4 is larger than the predetermined lateral distance A, then the clearance zone CZ will be considered free of obstacles.

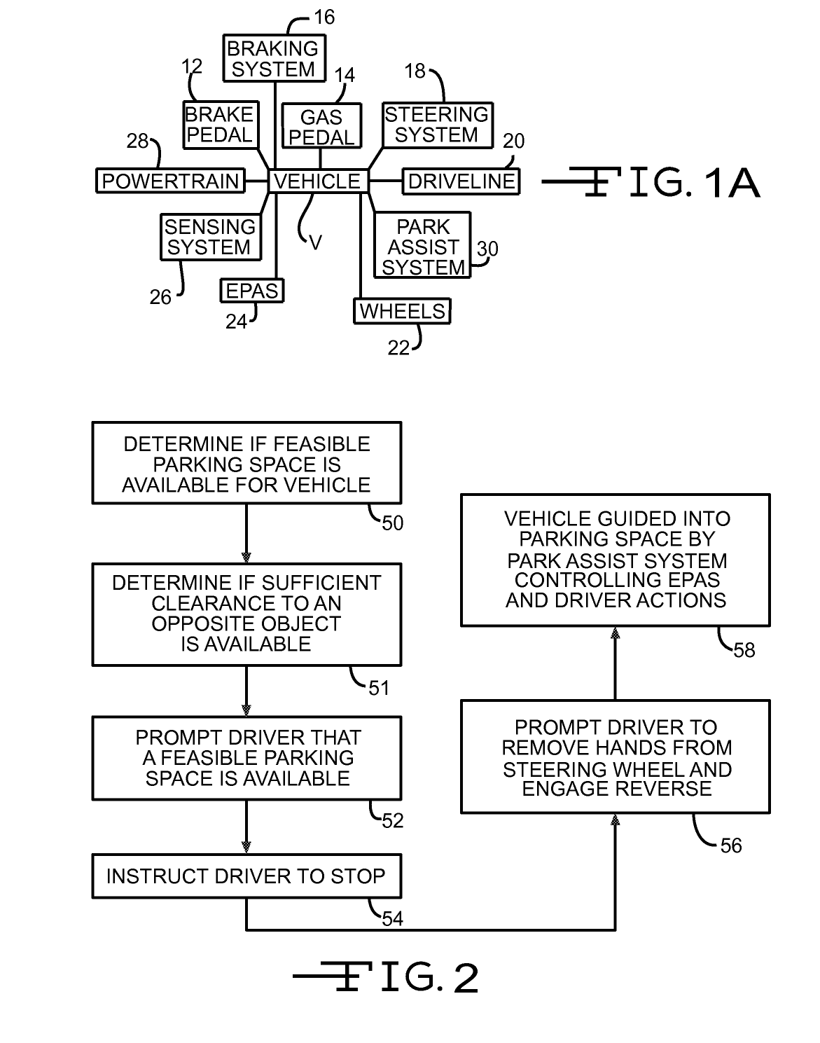

Referring now to FIG. 2, there is illustrated a flow chart of an embodiment of a method for parking a vehicle using the park assist system 30 of the present invention. As shown in FIG. 2, the method of the present invention includes a first step 50 in which the park assist system 30 determines if there is a feasible target parking space 10 available for parking of the vehicle V. To accomplish this, the park assist system 30 uses the sensor S1 of the sensing system 26. As discussed above, the sensor S1 determines whether there is a sufficient slot length 34 in which to park the vehicle V.

In a second step 51, the sensor S2 determines whether there is sufficient clearance to an obstacle, such as a vehicle V3, on the side of the vehicle V opposite the target parking space 10. If such an obstacle is in a predetermined clearance zone CZ, i.e., is less than the predetermined lateral distance A from the vehicle V, the obstacle is thus considered in a position to interfere with the successful maneuver of the vehicle V into the target parking space 10. It will be understood that the steps 50 and 51 may occur sequentially or simultaneously.

Once it is determined that a feasible target parking space 10 has been identified by the park assist system 30, and that there are no obstacles in the clearance zone CZ, the park assist system 30 in step 52 prompts the driver via a visual and/or audible interface that a feasible target parking space 10 is available. The park assist system 30 then recommends the parking space 10. One example of a visual interface is a text message displayed in a message center in the vehicle instrument panel. Alternatively, the visual interface may be a graphic image, icon, or other non-text representation. It will be understood that such a visual interface may be located at any other desired location in the vehicle, such as an overhead console.

Next, in step 54, the driver is instructed by the park assist system 30, either visually and/or audibly, to stop in order to accept the system assistance to park. Once the driver has stopped the park assist system 30 in step 56 will prompt the driver to remove his or her hands from a steering wheel of the steering system 18 and engage or shift the transmission of the powertrain system 28 into reverse gear. Once the driver has removed his or her hands from the steering wheel and engaged reverse gear, the park assist system 30 in step 58 will take over the steering wheel movement and control the EPAS system 24 to execute the calculated steering trajectory T based on the relative vehicle position to the neighboring objects, i.e., in FIG. 1 the vehicles V1 and V2 and the object 32. The park assist system 30 will prompt the driver when to stop, drive backward, and pull forward to park the vehicle V in the target parking space 10.

Although the target parking space 10 has been described as a parallel parking space between a forward first object and a rearward second object, the target parking space may alternatively be a rear perpendicular parking space, such as found in typical multi-vehicle parking lots and garages. Additionally, the target parking space 10 has been described as being on the right side of the vehicle V and the obstacle or vehicle V3 has been described as being on the left side of the vehicle V. Alternatively, the park assist system 30 may be used to identify a target parking space on the left side of the vehicle V and identify an obstacle or vehicle V3 on the right side of the vehicle V.

One advantage of the embodiments of the present invention is that the park assist system 30 and method of the operation thereof is capable of identifying obstacles on the side of the vehicle opposite the target parking space 10. As a result of this, the park assist system 30 can bypass or not recommend a target parking space 10 that otherwise may have sufficient slot length in which to park the vehicle, but for which an obstacle has been identified in the clearance zone CZ. As a result of this, the park assist system 30 and method of operation thereof minimizes the risk of collision with an object on the side of the vehicle opposite the target parking space 10.

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

What is claimed is:

1. A park assist system for parking a vehicle in a target parking space comprising:
a first sensing system which determines whether there is a sufficient slot length in a target parking space in which to park the vehicle; and
a second sensing system which determines whether an obstacle is located in a predetermined clearance zone on a side of the vehicle opposite the target parking space;
wherein a decision regarding whether to recommend parking the vehicle in the target parking space sensed by the first sensing system is dependent upon a determination that the clearance zone is free of obstacles.

2. The park assist system according to claim 1, wherein the first sensing system includes at least one ultrasonic sensor for determining whether there is the sufficient slot length in which to park the vehicle.

3. The park assist system according to claim 1, wherein the second sensing system includes at least one ultrasonic sensor for determining whether an obstacle is located in a predetermined clearance zone on a side of the vehicle opposite the target parking space.

4. The park assist system according to claim 1, wherein the target parking space is one of a parallel parking space and rear perpendicular parking space between a forward first object and a rearward second object.

5. The park assist system according to claim 1, wherein the second sensing system determines a measured lateral distance between the side of the vehicle opposite the target parking space and the obstacle.

6. The park assist system according to claim 5, wherein the park assist system compares the measured lateral distance to a predetermined lateral distance between the side of the vehicle opposite the target parking space and the obstacle.

7. The park assist system according to claim 6, wherein when the measured lateral distance between the side of the vehicle opposite the target parking space and the obstacle is less than the predetermined lateral distance between the side of the vehicle opposite the target parking space and the obstacle, the park assist system does not recommend the parking space sensed by the first sensing system.

8. The park assist system according to claim 1, wherein the second sensing system determines whether more than one obstacle is located in the predetermined clearance zone.

9. The park assist system according to claim 1, wherein the first sensing system includes a plurality of ultrasonic sensors mounted to the passenger side of the vehicle.

10. The park assist system according to claim 1, wherein the second sensing system includes a plurality of ultrasonic sensors mounted to the driver side of the vehicle.

11. A method for parking a vehicle in a target parking space, the vehicle having a sensing system and a park assist system operatively connected thereto, the method comprising the steps of:
scanning neighboring objects using a first sensor to determine if a target parking space is available for parking the vehicle, the neighboring objects including at least one object either in front of or behind the target parking space, wherein the first ultrasonic sensor provides an input signal to the park assist system;
scanning neighboring objects on the side of the vehicle opposite the target parking space using a second sensor to determine if a clearance zone on the side of the vehicle opposite the target parking space is free of obstacles, wherein the second ultrasonic sensor provides an input signal to the park assist system;
using the park assist system to determine whether there is a sufficient slot length in which to park the vehicle and to determine whether there is sufficient clearance to an identified obstacle on the side of the vehicle opposite the target parking space; and
parking the vehicle in the target parking space using the park assist system if there is sufficient slot length in which to park the vehicle and sufficient clearance to an identified obstacle on the side of the vehicle opposite the target parking space.

12. The method according to claim 11, wherein the first sensor is an ultrasonic sensor for determining whether there is the sufficient slot length in which to park the vehicle.

13. The method system according to claim 11, wherein the second sensor is an ultrasonic sensor for determining whether an obstacle is located in a predetermined clearance zone on a side of the vehicle opposite the target parking space.

14. The method according to claim 11, wherein the target parking space is one of a parallel parking space and rear perpendicular parking space between a forward first object and a rearward second object.

15. The method according to claim 11, wherein the second sensor determines a measured lateral distance between the side of the vehicle opposite the target parking space and the identified obstacle.

16. The method according to claim 15, further including comparing the measured lateral distance to a predetermined lateral distance between the side of the vehicle opposite the target parking space and the obstacle.

17. The method according to claim 16, wherein when the measured lateral distance between the side of the vehicle opposite the target parking space and the obstacle is less than the predetermined lateral distance between the side of the vehicle opposite the target parking space and the obstacle, the park assist system does not recommend the parking space sensed by the first sensing system to the vehicle driver.

18. The method according to claim 11, wherein the second sensor determines whether more than one obstacle is located in the predetermined clearance zone.

19. The method according to claim 11, wherein the first sensor includes a plurality of ultrasonic sensors mounted to the passenger side of the vehicle and the second sensor includes a plurality of ultrasonic sensors mounted to the driver side of the vehicle.

20. A method for parking a vehicle in a target parking space, the vehicle having a sensing system and a park assist system operatively connected thereto, the method comprising the steps of:
identifying a target parallel parking space;
scanning neighboring objects on the side of the vehicle opposite the target parking space using an ultrasonic sensor to determine if a clearance zone on the side of the vehicle opposite the target parking space is free of obstacles, wherein the ultrasonic sensor provides an input signal to the park assist system;
using the park assist system to determine whether there is sufficient clearance to an identified obstacle on the side of the vehicle opposite the target parallel parking space; and
parking the vehicle in the target parking space using the park assist system if there is sufficient slot length in which to park the vehicle and sufficient clearance to an identified obstacle on the side of the vehicle opposite the target parking space.
